(19) United States
(12) Patent Application Publication
(10) Pub. No.: US 2020/0349642 A1
(43) Pub. Date: Nov. 5, 2020

(54) CONFIGURING USER INTERFACE FUNCTIONALITY BASED ON BACKGROUND PROCESSING OF DATA RELATED TO PRE-QUALIFICATION STATUS

(71) Applicant: Capital One Services, LLC, McLean, VA (US)

(72) Inventors: Lokesh Vijay KUMAR, Frisco, TX (US); Venkata Satya PARCHA, McKinney, TX (US); Satish CHIKKAVEERAPPA, McKinney, TX (US); Sasi Kumar UNNIKRISHNAN, Plano, TX (US); Ponnazhakan SUBRAMANIAN, McKinney, TX (US)

(21) Appl. No.: 16/402,995

(22) Filed: May 3, 2019

(51) Int. Cl. G06Q 40/02; G06F 16/903

(52) U.S. Cl. CPC G06Q 40/025; G06F 16/90335

(57) ABSTRACT

A pre-qualification platform may obtain credit history information associated with a user and determine that the user is pre-qualified for one or more loans based on the credit history information associated with the user, wherein the credit history information may include a credit score associated with the user and values for one or more impact factors affecting the credit score. The pre-qualification platform may search an inventory for one or more products that the user is eligible to finance based on financing options associated with the one or more products and terms associated with the one or more loans for which the user is pre-qualified. The pre-qualification platform may populate a user interface to enable one or more actions related to the one or more financing options associated with the one or more products based on determining that the user is pre-qualified for the one or more loans.

### BACKGROUND

There are various credit products available to consumers, including vehicle loans, mortgage loans, home equity loans, student loans, personal loans, lines of credit, credit cards, and/or the like. In some cases, consumers may pre-qualify for a credit product prior to applying for the credit product. Pre-qualification generally refers to a process whereby a creditor (e.g., a bank, a credit union, a mortgage company, a vehicle financing company, a credit card company, and/or the like) evaluates the credit worthiness of a potential borrower and makes a tentative assessment regarding certain credit terms the creditor is willing to offer.

### SUMMARY

According to some implementations, a method may include receiving information that uniquely identifies a user; obtaining credit history information associated with the user based on the information that uniquely identifies the user, wherein the credit history information includes a credit score associated with the user and values for one or more impact factors affecting the credit score; determining one or more financing options for one or more products that are available to purchase through a shopping platform; populating a user interface based on the credit history information and the one or more financing options; determining whether the user is pre-qualified for the one or more financing options based on the credit score associated with the user and the one or more impact factors affecting the credit score; and configuring the user interface to enable one or more actions related to the one or more products that are available to purchase through the shopping platform based on whether the user is pre-qualified for the one or more financing options.

According to some implementations, a device may include one or more memories; and one or more processors, communicatively coupled to the one or more memories, configured to: obtain credit history information associated with a user, wherein the credit history information includes a credit score associated with the user and values for one or more impact factors affecting the credit score; determine that the user is pre-qualified for one or more loans based on the credit history information associated with the user; search an inventory for one or more products that the user is eligible to finance based on one or more financing options associated with the one or more products and terms associated with the one or more loans for which the user is pre-qualified; and populate a user interface to enable one or more actions related to the one or more financing options associated with the one or more products based on determining that the user is pre-qualified for the one or more loans.

According to some implementations, a non-transitory computer-readable medium may store one or more instructions. The one or more instructions, when executed by one or more processors, may cause the one or more processors to: receive a request to track information related to a credit score associated with a user from a user device; obtain credit history information associated with the user via a soft inquiry that does not impact the credit score associated with the user, wherein the credit history information includes the credit score associated with the user and values for one or more impact factors affecting the credit score; determine, for multiple lenders, pre-qualification criteria for one or more loans; identify, among the multiple lenders, a set of lenders with respect to which the user is pre-qualified for the one or more loans, based on the credit history information associated with the user and the pre-qualification criteria for the multiple lenders; and populate a user interface accessible to the user device to enable, via the user interface, one or more actions related to the one or more loans for which the user is pre-qualified.

### BRIEF DESCRIPTION OF THE DRAWINGS

FIGS. 1A-1C are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for configuring user interface functionality based on background processing of data related to pre-qualification status.

### DETAILED DESCRIPTION

The following detailed description of example implementations refers to the accompanying drawings. The same reference numbers in different drawings may identify the same or similar elements.

Prior to submitting an application for a credit product (e.g., a vehicle loan, a mortgage loan, a personal loan, a line of credit, a credit card, and/or the like), a prospective borrower may seek and/or obtain pre-qualification for the credit product. Pre-qualification (sometimes referred to as pre-approval and/or the like) is typically a preliminary step in a credit or loan approval process, in which a lender or other creditor provides the prospective borrower with an estimated amount, an estimated rate, and/or other tentative terms based on general information such as a credit score, a debt-to-income ratio, and/or the like. If the prospective borrower pre-qualifies, the prospective borrower may proceed with a formal approval and/or application process in which the lender may collect additional information about the prospective borrower, verify the information that was provided during pre-qualification, and/or the like.

In many cases, because rates, terms, pre-qualification criteria, and/or the like may vary among different lenders, consumers contemplating a particular credit product may go through the pre-qualification process with multiple lenders in order to compare offers. Furthermore, in some cases, a consumer shopping for a large purchase (e.g., a home, a vehicle, and/or the like) may obtain a new pre-qualification letter for each item that the consumer is considering. For example, when submitting an offer on a home, a vehicle, or other item, a prospective buyer often provides a pre-qualification letter tailored to the particular item to make the offer more attractive, obtain added leverage when negotiating price, and/or the like. Accordingly, pre-qualification processes can consume substantial computing resources (e.g., processor resources, memory resources, communication resources, and/or the like) because the consumer may have to submit an online form, call a lender, retrieve account information, and/or the like each time that the pre-qualification process is carried out. Furthermore, each time that a consumer submits a request to pre-qualify (e.g., for a particular credit product, a particular item, and/or the like), the lender may use processor resources, memory resources, communication resources, and/or the like to communicate with various entities (e.g., credit bureaus, financial institutions, and/or the like), evaluate creditworthiness, calculate terms, and/or the like.

Some implementations described herein may utilize a pre-qualification platform to process data related to a pre-qualification status for one or more users and configure a user interface to enable or disable one or more actions based on the pre-qualification status. For example, the pre-qualification platform may obtain information that uniquely identifies a user, and the pre-qualification platform may use the information that uniquely identifies the user to obtain credit history information associated with the user via a soft pull (e.g., a credit check that does not place an inquiry on a consumer credit report). In some implementations, the information that uniquely identifies the user may be a social security number, an account number, and/or another suitable identifier available to the pre-qualification platform (e.g., from a source that links to or otherwise interfaces with the pre-qualification platform, such as a credit score tracking service, a financial institution, a browser extension, a vehicle shopping platform, a real estate platform, an input form, and/or the like). The pre-qualification platform may determine, in one or more background processes (e.g., processes that do not involve interaction with the user), whether the user is pre-qualified for one or more credit products based on the credit history information. In some implementations, based on whether the user pre-qualifies for the one or more credit products, the pre-qualification platform may enable and/or disable one or more actions in a user interface accessible to the user.

In this way, by processing the credit history information associated with the user in one or more background processes and enabling and/or disabling one or more actions in the user interface based on whether the user is pre-qualified for one or more credit products, implementations described herein may conserve computing resources (e.g., processor resources, memory resources, communication resources, and/or the like) that would otherwise be wasted when the user interacts with the user device to input details to request pre-qualification, communicate with financial institutions to inquire about balances on existing debts, and/or the like. Furthermore, by determining whether the user is pre-qualified for the one or more credit products, actions may be enabled or disabled in the user interface to conserve computing resources that would otherwise be wasted by processing loan or credit applications that are unlikely to be approved (e.g., a one-click pre-qualification option may be enabled only for users that are determined to be pre-qualified for the one or more credit products, and the one-click pre-qualification option may be disabled for users that do not pre-qualify).

Moreover, in some implementations, the pre-qualification platform may be associated with multiple lenders that originate loans or other suitable credit products through the pre-qualification platform. Accordingly, the pre-qualification platform may determine, for the multiple lenders, a set of one or more lenders with respect to which the user is able to pre-qualify for one or more credit products and populate the user interface to enable one or more actions related to the one or more credit products for which the user is pre-qualified. For example, based on a credit score of the user, a debt-to-income ratio of the user, and/or the like, the user may pre-qualify for a loan based on pre-qualification criteria for some lenders while not pre-qualifying based on pre-qualification criteria for other lenders. In this way, by determining a set of one or more lenders with respect to which the user is able to pre-qualify and populating the user interface accordingly, implementations described herein may conserve computing resources that would otherwise be consumed if the user were to communicate with each of the multiple lenders independently to submit separate pre-qualification requests (e.g., when rate shopping).

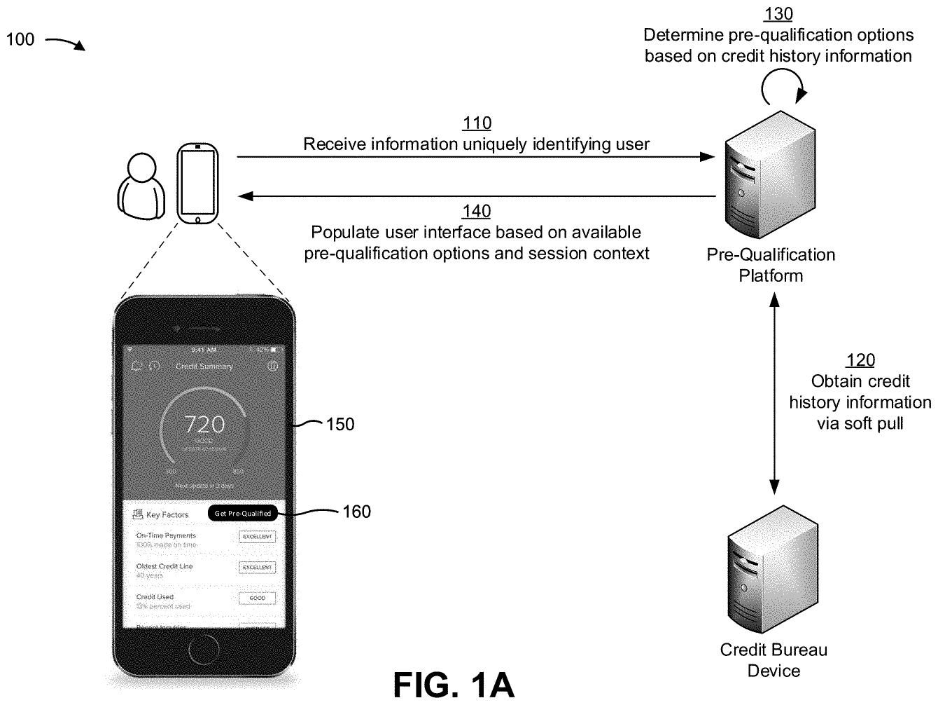

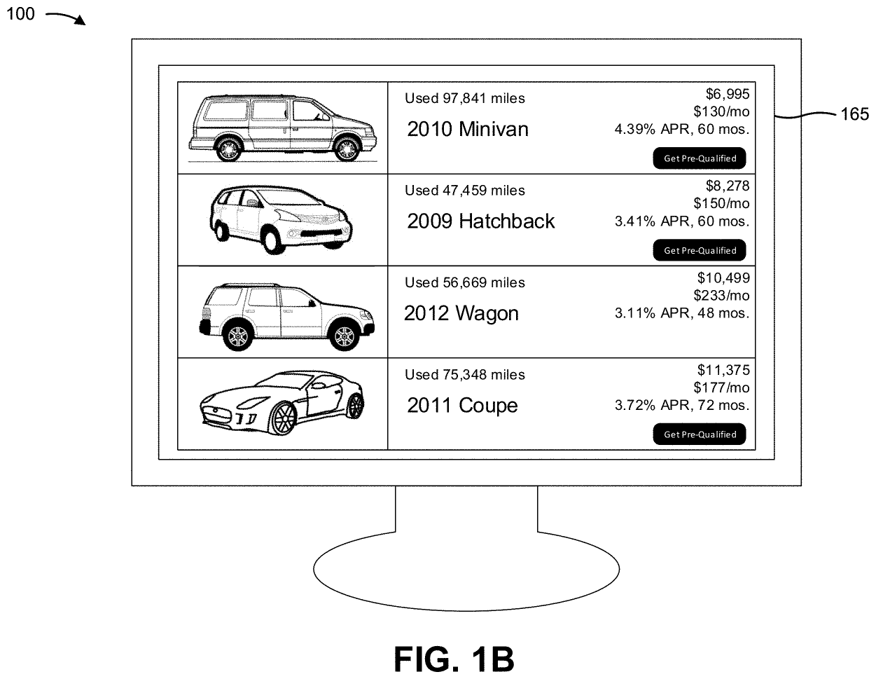

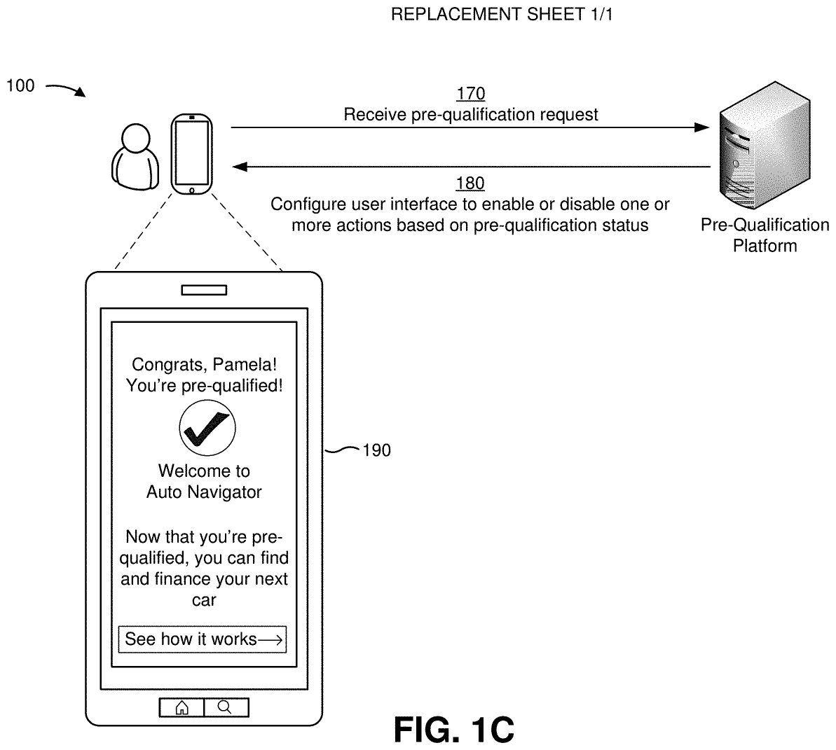

FIGS. 1A-1C are diagrams of one or more example implementations 100 described herein. As will be described in further detail herein, example implementation(s) 100 can include a pre-qualification platform that can execute one or more background processes to communicate with a credit bureau device, obtain credit history information associated with a user from the credit bureau device, and determine whether the user is pre-qualified for one or more credit products based on the credit history information. In some implementations, additional information available to the pre-qualification platform (e.g., a monthly income, account balances, and/or the like) may be used as part of the pre-qualification determination. Furthermore, example implementation(s) 100 may include a user device that can interact with the pre-qualification platform (e.g., to view a credit score of the user, to access one or more accounts, to interact with a shopping platform that provides one or more financing options, and/or the like), and the pre-qualification platform may automatically populate a user interface accessible to the user device to enable and/or disable certain actions based on the pre-qualification options (if any) that are available to the user.

As shown in FIG. 1A, the pre-qualification platform can receive or otherwise obtain information that uniquely identifies a particular user (e.g., from a service that tracks a credit score for the user, a financial institution that manages one or more accounts for the user, and/or the like), and the information that uniquely identifies the particular user can be used to obtain credit history information for the particular user. The pre-qualification platform may determine one or more pre-qualification options for the user and populate a user interface accessible to the user accordingly. In example implementation(s) 100, the user interface may be associated with one or more financial products or other products (e.g., a vehicle, a home, furniture, and/or the like) for which one or more financial products may be associated. The one or more pre-qualification options may be associated with a particular financial product or the other products for which a financial product may be associated.

For example, in some implementations, the user interface may be associated with a vehicle shopping platform that provides detailed vehicle information of an inventory of vehicles available at one or more dealerships. The user interface may be associated with a financial institution that may provide financing options for one or more vehicles in the inventory of vehicles. The one or more pre-qualification options may be presented on the user interface in association with each vehicle. In some implementations, a pre-qualification option may be presented only upon determining that the user may be successful in pre-qualifying for financing of the vehicle based on the obtained information specific to the user, as described in further detail elsewhere herein. For example, as shown in FIG. 1B, the user interface may be associated with a vehicle shopping platform, and the pre-qualification option may be presented only with respect to one or more vehicles for which the user may be able to pre-qualify for financing.

As shown in FIG. 1C, the user may submit a pre-qualification request to the pre-qualification platform, which may determine a pre-qualification status for a user at one more lenders based on available financial data associated with the user (e.g., the user's credit score, existing debts, and/or the like). In some implementations, the pre-qualification platform may be associated with multiple lenders that offer credit products to users of pre-qualification platform, and the pre-qualification status may be determined with respect to the multiple lenders based on the available financial data associated with the user. As further shown in FIG. 1C, the pre-qualification platform may configure functionality in a user interface (e.g., enabling or disabling certain actions) based on the pre-qualification status for the user at the one more lenders.

As shown in FIG. 1A, and by reference number 110, the pre-qualification platform may receive information that uniquely identifies a user associated with a user device. For example, in some implementations, the pre-qualification platform may provide, interface with, or otherwise be associated with a service to track the user's credit score, credit history information, and/or the like. Accordingly, when the user registers for the service, the user may provide a name, social security number, and/or other information that enables the service to track the user's credit score, credit history information, and/or the like. Additionally, or alternatively, the pre-qualification platform may be associated with one or more financial institutions where the user holds one or more accounts (e.g., a checking account, a savings account, a credit card account, a vehicle loan account, a home mortgage account, and/or the like). The user may generally provide the information that uniquely identifies the user to the one or more financial institutions (e.g., when applying to open the one or more accounts), and the financial institution(s) may make the information that uniquely identifies the user available to the pre-qualification platform. Additionally, or alternatively, the pre-qualification platform may obtain the information that uniquely identifies the user from a software application running on the user device (e.g., a browser extension linked to the pre-qualification platform, the financial institution(s) associated with the pre-qualification platform, and/or the like), an input form (e.g., in which the user requests pre-qualification options, financing information, a credit score, and/or the like), and/or another suitable source linked to or otherwise associated with the pre-qualification platform.

As further shown in FIG. 1A, and by reference number 120, the pre-qualification platform may use the information that uniquely identifies the user to obtain credit history information associated with the user from one or more credit bureau devices via a soft pull (sometimes referred to as a soft inquiry and/or the like). For example, the credit bureau device(s) may be associated with one or more data collection agencies that collect, from various creditors, credit history information relating to individual borrowing and bill-paying habits (e.g., existing debts, payment histories, payment delinquencies, monthly payments, and/or the like) and make the collected credit history information available to private lenders, consumer reporting agencies, credit reference agencies, credit reporting bodies, and/or the like. As described in further detail elsewhere herein, the credit history information may be available via a hard pull (or hard inquiry) that may be recorded in an individual's credit report and potentially affect the individual's credit score, or the credit history information may be alternatively be available via a soft pull that is not recorded in the individual's credit report and does not affect the individual's credit score.

In particular, a hard pull (or hard inquiry) occurs when an individual submits an application for a credit product (e.g., a vehicle loan, a mortgage, a credit card, and/or the like) and one or more entities check the individual's credit to make a decision regarding the application for the credit product. Hard pulls generally have an adverse effect on the individual's credit score and/or remain in the individual's credit history (e.g., for a given time period) because an application for additional credit may indicate that the individual is at greater risk of not paying back existing debts. On the other hand, a soft pull (or soft inquiry) generally refers to a credit inquiry that occurs when an individual checks his or her own credit, when a financial institution that has an existing relationship with the individual checks the individual's credit, when a potential employer is granted permission to check the individual's credit, when an entity checks the individual's credit in relation to a pre-qualification or pre-approval offer, and/or the like. Soft pulls typically do not affect the individual's credit score because the individual either did not request the inquiry or the inquiry was solely for informational purposes.

In some implementations, as mentioned above, the pre-qualification platform may obtain the credit history information associated with the user via a soft pull. In this way, the credit history information may be obtained to inform the user about credit products for which the user has been determined to be qualified (e.g., including an estimated amount, rate, and/or term) without having an adverse impact on the user's credit score. Furthermore, in some implementations, the pre-qualification platform may execute one or more background processes to obtain the credit history information (e.g., at scheduled intervals, such as weekly or monthly, in response to a trigger event, and/or the like). For example, the one or more background processes may be child processes created by a control process that manages the pre-qualification process. Accordingly, the background processes may be executed to perform the task of obtaining the credit history information from the credit bureau device independent of the control process, which may be free to perform other designated tasks. In this way, obtaining the credit history information using the one or more background processes may conserve computing resources that would be otherwise consumed by the user requesting that the credit history information be obtained, waiting for the request to be processed, and/or the like. Furthermore, by using the background processes to obtain the credit history information, computing resources available to the control process may be increased, efficiency may be increased, and/or the like.

Additionally, or alternatively, if the user holds one or more accounts at the one or more financial institutions that are associated with the pre-qualification platform, the pre-qualification platform may obtain the credit history information and/or additional financial data from the one or more financial institutions. For example, in some implementations, the information obtained from the one or more financial institutions can be analyzed to determine parameters such as an income and/or employment status of the user (e.g., based on payroll deposit patterns), balance histories, payment histories, savings activities, and/or the like. Additionally, or alternatively, the pre-qualification platform may obtain, from the one or more financial institutions, credit history information and/or additional financial data associated with other users that may have one or more characteristics in common with the user (e.g., other users with a credit score in a similar range as the user, other users with similar demographic profiles, and/or the like). In this way, the pre-qualification platform may obtain additional data points to verify, interpret, supplement, or otherwise analyze the user-specific credit history information, which may increase accuracy of one or more predictions used to determine whether the user is pre-qualified for one or more credit products (e.g., based on the user's creditworthiness).

As further shown in FIG. 1A, and by reference number 130, the pre-qualification platform may determine one or more pre-qualification options for the user based on the credit history information associated with the user, which may include a credit score obtained from the credit bureau device, information in a credit report obtained from the credit bureau device, financial data obtained from the one or more financial institutions, and/or the like. For example, the credit score obtained from the credit bureau device may include a current credit score of the user, one or more previous credit scores of the user (e.g., indicating fluctuations in the credit score over a particular time period), one or more impact factors affecting the credit score, and/or the like. For example, the one or more impact factors may include a bill payment history (e.g., whether the user makes payments in a timely fashion, whether the user has any current or previous delinquencies, charge-offs, collections, bankruptcies, repossessions, tax liens, foreclosures, and/or the like), a debt level and/or credit utilization (e.g., a total debt owed, a ratio of credit card balances to credit limits, a ratio of outstanding loan balances to original loan amounts, and/or the like), a credit history age (e.g., an age of an oldest account, an average of all accounts, and/or the like), types of credit accounts (e.g., revolving credit card accounts, installment loans, home mortgages, and/or the like), credit inquiries within a threshold time period, accounts opened within a threshold time period, and/or the like.

In some implementations, the pre-qualification platform may evaluate the credit score associated with the user, the information in the credit report associated with the user, the financial data obtained from the one or more financial institutions, and/or the like to predict the user's overall creditworthiness. For example, the user's overall creditworthiness may be represented as a credit rating, a score, or another suitable parameter that indicates a probability that the user will be able to pay back a debt, a probability that the user will default on the debt, fail to make payments on time, and/or the like. Accordingly, the user's overall creditworthiness can be used to screen the user in advance of providing one or more pre-qualification offers (e.g., providing the pre-qualification offer(s) only to certain users that have already been determined to be pre-qualified), to determine a maximum pre-qualified credit or loan amount for the user, estimate an interest rate and/or other terms for the pre-qualification offer(s), and/or the like.

For example, if the user pre-qualifies for one or more credit products, the maximum pre-qualified credit or loan amount, the estimated interest rate, and/or the like can be determined based on a risk-based pricing model in which the user may pre-qualify for a lower amount and/or a higher interest rate if the user has a poor credit repayment history, court-adjudicated debt obligations (e.g., tax liens or bankruptcies), high credit utilization, many hard credit inquiries that may indicate that the user is short on funds and/or is planning to accumulate more debt, and/or the like. On the other hand, the user may pre-qualify for a higher amount and/or a lower interest rate if the user consistently makes payments on time, has a low credit utilization, has a long credit history that demonstrates experience handling credit, has different types of accounts (e.g., revolving accounts, installment loans for different asset types, and/or the like) that indicates experience managing different types of credit, and/or the like.

In some implementations, the pre-qualification platform may use a machine learning model, such as a creditworthiness prediction model, to generate a score that represents a probability that the user will be able to pay back a debt and/or default on a debt. For example, the creditworthiness prediction model may be trained (e.g., by the pre-qualification platform or another device) based on historical credit data that relates to credit scores, credit ratings, values for various credit score impact factors, debt repayment patterns, debt default patterns, income, employment status, and/or the like. Using the historical credit data and the credit history information associated with the user (e.g., including the user's credit score, impact factors, other financial data, and/or the like) as inputs to the creditworthiness prediction model, the pre-qualification platform may determine whether the user is pre-qualified for one or more credit products (e.g., based on whether the score representing the user's creditworthiness satisfies a threshold value). In some implementations, if the user is determined to be pre-qualified for one or more credit products, the pre-qualification platform may further determine one or more pre-qualified terms for the one or more credit products (e.g., a maximum amount or range for a pre-qualified loan and/or credit line, an interest rate or interest rate range for the pre-qualified loan and/or credit line, promotional offers such as a lower introductory rate, and/or the like).

In some implementations, as mentioned above, the pre-qualification platform may train the creditworthiness prediction model using the historical credit data to determine whether a user is pre-qualified for one or more credit products, to determine one or more pre-qualified terms for the one or more credit products, and/or the like. As an example, the pre-qualification platform may determine that past credit score values, credit rating values, impact factor values, and/or the like are associated with a threshold probability of a borrower repaying a debt, defaulting on a debt, and/or the like.

In some implementations, the pre-qualification platform may perform a data preprocessing operation when generating the creditworthiness prediction model. For example, the pre-qualification platform may preprocess data (e.g., credit history information obtained from the credit bureau device, account history data obtained from one or more financial institutions, and/or the like) to remove non-ASCII characters, white spaces, confidential data, and/or the like. In this way, the pre-qualification platform may organize thousands, millions, or billions of data entries for machine learning and model generation.

In some implementations, the pre-qualification platform may perform a training operation when generating the creditworthiness prediction model. For example, the pre-qualification platform may portion credit history information obtained from the credit bureau device, account history data obtained from one or more financial institutions, and/or the like into a training set (e.g., a set of data to train the model), a validation set (e.g., a set of data used to evaluate a fit of the model and/or to fine tune the model), a test set (e.g., a set of data used to evaluate a final fit of the model), and/or the like. In some implementations, the pre-qualification platform may preprocess and/or perform dimensionality reduction to reduce the credit history information, the account history data, and/or the like to a minimum feature set. In some implementations, the pre-qualification platform may train the creditworthiness prediction model on this minimum feature set, thereby reducing processing to train the machine learning model, and may apply a classification technique, to the minimum feature set.

In some implementations, the pre-qualification platform may use a classification technique, such as a logistic regression classification technique, a random forest classification technique, a gradient boosting machine learning (GBM) technique, and/or the like, to determine a categorical outcome (e.g., whether the user is pre-qualified for one or more credit products). Additionally, or alternatively, the pre-qualification platform may use a naïve Bayesian classifier technique. In this case, the pre-qualification platform may perform binary recursive partitioning to split the data of the minimum feature set into partitions and/or branches and use the partitions and/or branches to perform predictions (e.g., as to whether the user is pre-qualified for one or more credit products). Based on using recursive partitioning, the pre-qualification platform may reduce utilization of computing resources relative to manual, linear sorting and analysis of data points, thereby enabling use of thousands, millions, or billions of data points to train a model, which may result in a more accurate model than using fewer data points.

Additionally, or alternatively, the pre-qualification platform may use a support vector machine (SVM) classifier technique to generate a non-linear boundary between data points in the training set. In this case, the non-linear boundary is used to classify test data into a particular class (e.g., a class indicating that the user pre-qualifies for a credit product, a class indicating that the user does not pre-qualify for a credit product, and/or the like).

Additionally, or alternatively, the pre-qualification platform may train the creditworthiness prediction model using a supervised training procedure that includes receiving input to the model from a subject matter expert, which may reduce an amount of time, an amount of processing resources, and/or the like to train the creditworthiness prediction model relative to an unsupervised training procedure. In some implementations, the pre-qualification platform may use one or more other model training techniques, such as a neural network technique, a latent semantic indexing technique, and/or the like. For example, the pre-qualification platform may perform an artificial neural network processing technique (e.g., using a two-layer feedforward neural network architecture, a three-layer feedforward neural network architecture, and/or the like) to perform pattern recognition with regard to patterns in the credit history information, the account history information, and/or the like. In this case, using the artificial neural network processing technique may improve an accuracy of a model (e.g., the creditworthiness prediction model) generated by the pre-qualification platform by being more robust to noisy, imprecise, or incomplete data, and by enabling the pre-qualification platform to detect patterns and/or trends undetectable to human analysts or systems using less complex techniques.

Accordingly, the pre-qualification platform may use any number of artificial intelligence techniques, machine learning techniques, deep learning techniques, and/or the like to determine whether a user is pre-qualified for one or more credit products, to determine one or more pre-qualified terms for the one or more credit products, and/or the like.

In some implementations, the pre-qualification platform may be associated with one or more lenders, which may include banks, credit unions, mortgage companies, vehicle financing companies, credit card companies, merchants selling items on a shopping platform associated with the pre-qualification platform, and/or the like. The one or more lenders may each have certain financing requirements and/or pre-qualification criteria, and the pre-qualification platform may determine whether the user is pre-qualified based on the financing requirements, pre-qualification criteria, and/or the like for each lender. In this way, even if the user does not pre-qualify for a credit product at one or more lenders, the pre-qualification platform may determine a set of one or more lenders where the user is pre-qualified and thereby provide additional pre-qualification options to the user and conserve computing resources that would otherwise be consumed if the user requested pre-qualification separately through each lender.

As further shown in FIG. 1A, and by reference number 140, the pre-qualification platform may populate a user interface accessible to the user device based on one or more pre-qualification options that may be available to the user of the user device and a context of a session with the user device. For example, as mentioned above, the pre-qualification platform may be associated with a service that can be used to track the user's credit score and/or other credit history information, one or more financial institutions where the user holds one or more accounts, a shopping platform that provides one or more financing options for items that are available to purchase (e.g., an auto loan to finance a vehicle purchase), and/or the like.

For example, in FIG. 1A, reference number 150 illustrates an example user interface that has been populated based on a session context in which the user device accessed the service for tracking the user's credit score. In this example, the user interface is populated to show a credit summary for the user, including a current credit score, a date when the current credit score will be updated next, one or more impact factors affecting the current credit score, and/or the like. In addition, as further shown in FIG. 1A, and by reference number 160, the user interface has been populated to enable a pre-qualification action (e.g., to obtain pre-qualification for one or more credit products). For example, as mentioned above, the pre-qualification platform may have previously determined that the user satisfies one or more minimum requirements to pre-qualify for the one or more credit products (e.g., a vehicle loan, a home mortgage, a personal loan, a credit card, and/or the like), and the action to obtain pre-qualification may be enabled based on the previous determination that the user satisfies the one or more minimum requirements to pre-qualify for the one or more credit products. Accordingly, because the pre-qualification determination has already been made on a back-end by the pre-qualification platform, the user may simply select the enabled option in the user interface to view credit products for which the user is pre-qualified, explore more specific terms for the credit product(s) for which user has been determined to satisfy the minimum requirements (e.g., amounts, interest rates, term length, and/or the like), search or browse the shopping platform for items (e.g., vehicles) that are available to finance using the credit products for which the user is pre-qualified (e.g., based on a maximum amount for which the user is pre-qualified), and/or the like.

In some cases, the pre-qualification determination may be made in connection with a shopping platform that provides one or more financing options for items that are available to purchase (e.g., while the user is interacting with the shopping platform), and the user interface may be populated to include the option to obtain pre-qualification on a dynamic basis depending on one or more items that are shown in the user interface. For example, the option to obtain pre-qualification may be enabled with respect to one or more items that have a sales price, a monthly payment, and/or the like that is less than a maximum amount for which the user is pre-qualified, within a threshold of the maximum amount for which the user is pre-qualified, and/or the like. Additionally, or alternatively, the option to obtain pre-qualification may be disabled with respect to one or more items that have a sales price, a monthly payment, and/or the like that is more than the maximum amount for which the user is pre-qualified, a threshold amount above the maximum amount for which the user is pre-qualified, and/or the like. For example, as shown in FIG. 1B, the user may be browsing a vehicle shopping platform, and the pre-qualification platform may have determined that the user is pre-qualified for a loan up to $9000 or a loan with a monthly payment under $200. Accordingly, as shown in FIG. 1B, and by reference number 165, the option to obtain pre-qualification may be enabled for three vehicles that have a sales price under $9000 and/or a monthly payment under $200 (i.e., the 2010 minivan and the 2009 hatchback, which satisfy both conditions, and the 2011 coupe, which has a monthly payment under $200). Furthermore, the option to obtain pre-qualification is disabled with respect to a fourth vehicle (the 2012 wagon) that has a sales price above the maximum loan amount for which the user was determined to be pre-qualified and a monthly payment that is higher than the maximum monthly payment for which the user was determined to be pre-qualified.

In this way, the pre-qualification option may be enabled only with respect to one or more items that the user has already been determined to be eligible to finance, which may conserve computing resources that would otherwise be wasted by a user submitting a request for pre-qualification with respect to items that the user is not eligible to finance, processing the pre-qualification request, and/or the like.

As shown in FIG. 1C, and by reference number 170, the pre-qualification platform may receive, from the user device, a pre-qualification request (e.g., based on the user selecting the option to obtain the pre-qualification, as described elsewhere herein). As further shown in FIG. 1C, and by reference number 180, the pre-qualification platform may configure the user interface to enable or disable one or more actions based on the pre-qualification status of the user. For example, in some implementations, the pre-qualification platform may configure the user interface to enable an action to apply for one or more credit products for which the user has been determined to be pre-qualified. Additionally, or alternatively, the pre-qualification platform may configure the user interface to enable an action to search an inventory (e.g., a vehicle inventory) associated with a shopping platform for one or more items that the user is pre-qualified or otherwise eligible to finance. For example, as further shown in FIG. 1C, and by reference number 190, the user interface has been populated to indicate that the user is pre-qualified for a vehicle loan and to enable an action to search a vehicle inventory for vehicles that have financing options within the scope of the user's pre-qualification. For example, the user may be pre-qualified for a vehicle loan up to a certain amount, and the user may search for vehicles that are listed at prices within a threshold of the amount up to which the user is pre-qualified (e.g., to account for possible price negotiations, a down payment and/or trade-in that may cover a difference between a sales price and a loan amount, and/or the like).

Additionally, or alternatively, if the user does not pre-qualify for any credit products and/or fails to pre-qualify with respect to one or more specific credit products, one or more specific lenders, and/or the like, the pre-qualification platform may configure the user interface to enable an action to simulate one or more changes to the user's credit history information that would result in the user being able to obtain pre-qualification. In particular, the user may input information to vary values for one or more impact factors affecting the user's credit score to determine what effect, if any, the variations would have on the user's pre-qualification status. For example, the user may simulate changes to lower one or more outstanding balances, maintain a history of on-time payments, avoid new hard credit inquiries and/or account opening events for a particular time period, raise a credit limit on one or more accounts, cancel or close one or more accounts, eliminate a balance on one or more accounts, and/or the like. In this way, even if the user does not pre-qualify for any credit products and/or fails to pre-qualify with respect to one or more specific credit products, specific lenders, and/or the like, the pre-qualification platform may enable certain actions to help the user better understand how to improve his/her creditworthiness.

As indicated above, FIGS. 1A-1C are provided as one or more examples. Other examples may differ from what is described with regard to FIGS. 1A-1C.

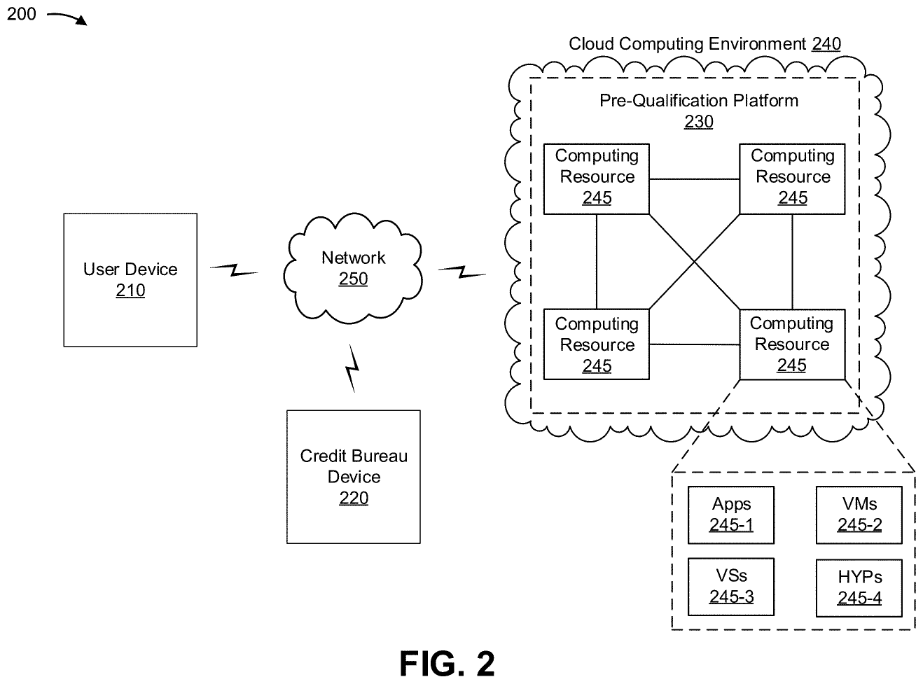

FIG. 2 is a diagram of an example environment 200 in which systems and/or methods described herein may be implemented. As shown in FIG. 2, environment 200 may include a user device 210, a credit bureau device 220, a pre-qualification platform 230 in a cloud computing environment 240 that includes a set of one or more computing resources 245, and a network 250. Devices of environment 200 may interconnect via wired connections, wireless connections, or a combination of wired and wireless connections.

User device 210 includes one or more devices capable of receiving, generating, storing, processing, and/or providing information associated with a pre-qualification status related to one or more credit products. For example, user device 210 may include a communication and/or computing device, such as a mobile phone (e.g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or a similar type of device. In some implementations, user device 210 may access pre-qualification platform 230 to view information related to a credit score, access one or more accounts, access a shopping platform listing one or more items that have available financing options, and/or the like. User device 210 may receive, from pre-qualification platform 230, information related to a pre-qualification status for one or more credit products based on previously stored information associated with a user of user device 210 that is accessible to pre-qualification platform 230.

Credit bureau device 220 includes one or more devices, such as a server device or a group of server devices, capable of receiving, generating, storing, processing, and/or providing information associated with consumer credit history information. For example, credit bureau device 220 may be configured to collect, aggregate, or otherwise obtain credit history information that relates to individual borrowing and bill-paying habits (e.g., existing debts, payment histories, payment delinquencies, monthly payments, and/or the like), which may be made available to other devices in environment 200. For example, as described elsewhere herein, the credit history information may be available via a soft pull that is not recorded in the individual's credit report and does not affect the individual's credit score, or the credit history information may be alternatively via a hard pull (or hard inquiry) that may be recorded in an individual's credit report and potentially affect the individual's credit score.

Pre-qualification platform 230 includes one or more devices capable of receiving, generating, storing, processing, and/or providing information associated with a pre-qualification status of one or more users with respect to one or more credit products. For example, as described elsewhere herein, pre-qualification platform 230 can receive or otherwise obtain information that uniquely identifies a user (e.g., from a service that tracks a credit score for the user, a financial institution that manages one or more accounts for the user, and/or the like) and use such information to obtain credit history information for the particular user (e.g., from credit bureau device 220). Pre-qualification platform 230 may determine one or more pre-qualification options for the user and populate a user interface accessible to user device 210 accordingly. In some implementations, pre-qualification platform 230 may be associated with multiple lenders that offer credit products to a user of pre-qualification platform 230, which may determine pre-qualification status for the user based on available financial data associated with the user (e.g., the user's credit score, existing debts, income, and/or the like). Accordingly, user device 210 may submit a pre-qualification request to pre-qualification platform 230, which may configure functionality (e.g., enabling or disabling certain actions) in a user interface accessible to user device 210 based on the user's pre-qualification status.

In some implementations, as shown, pre-qualification platform 230 can be hosted in a cloud computing environment 240. Notably, while implementations described herein describe pre-qualification platform 230 as being hosted in cloud computing environment 240, in some implementations, pre-qualification platform 230 can be non-cloud-based (e.g., can be implemented outside of a cloud computing environment) or partially cloud-based.

Cloud computing environment 240 includes an environment that hosts pre-qualification platform 230. Cloud computing environment 240 can provide computation services, software services, data access services, storage services, and/or other services that do not require end-user knowledge of a physical location and configuration of system(s) and/or device(s) that host pre-qualification platform 230. As shown, cloud computing environment 240 can include a set of one or more computing resources 245 (referred to collectively as “computing resources 245” and individually as “computing resource 245”).

Computing resource 245 includes one or more personal computers, workstation computers, server devices, or other types of computation and/or communication devices. In some implementations, computing resource 245 can host pre-qualification platform 230. The cloud resources can include compute instances executing in computing resource 245, storage devices provided in computing resource 245, data transfer devices provided by computing resource 245, and/or the like. In some implementations, computing resource 245 can communicate with other computing resources 245 via wired connections, wireless connections, or a combination of wired and wireless connections.

As further shown in FIG. 2, computing resource 245 includes a group of cloud resources, such as one or more applications (“APPs”) 245-1, one or more virtual machines (“VMs”) 245-2, virtualized storage (“VSs”) 245-3, one or more hypervisors (“HYPs”) 245-4, and/or the like.

Application 245-1 includes one or more software applications that can be provided to or accessed by user device 210, credit bureau device 220, and/or the like. Application 245-1 can eliminate a need to install and execute the software applications on user device 210, credit bureau device 220, and/or the like. For example, application 245-1 can include software associated with pre-qualification platform 230 and/or any other software capable of being provided via cloud computing environment 240. In some implementations, one application 245-1 can send information to and/or receive information from one or more other applications 245-1, via virtual machine 245-2.

Virtual machine 245-2 includes a software implementation of a machine (e.g., a computer) that executes programs like a physical machine. Virtual machine 245-2 can be either a system virtual machine or a process virtual machine, depending upon use and degree of correspondence to any real machine by virtual machine 245-2. A system virtual machine can provide a complete system platform that supports execution of a complete operating system (“OS”). A process virtual machine can execute a single program, and can support a single process. In some implementations, virtual machine 245-2 can execute on behalf of a user (e.g., a user of user device 210, credit bureau device 220, and/or the like), and can manage infrastructure of cloud computing environment 240, such as data management, synchronization, or long-duration data transfers.

Virtualized storage 245-3 includes one or more storage systems and/or one or more devices that use virtualization techniques within the storage systems or devices of computing resource 245. In some implementations, within the context of a storage system, types of virtualizations can include block virtualization and file virtualization. Block virtualization can refer to abstraction (or separation) of logical storage from physical storage so that the storage system can be accessed without regard to physical storage or heterogeneous structure. The separation can provide administrators of the storage system with flexibility in how the administrators manage storage for end users. File virtualization can eliminate dependencies between data accessed at a file level and a location where files are physically stored. This can enable optimization of storage use, server consolidation, and/or performance of non-disruptive file migrations.

Hypervisor 245-4 can provide hardware virtualization techniques that allow multiple operating systems (e.g., “guest operating systems”) to execute concurrently on a host computer, such as computing resource 245. Hypervisor 245-4 can present a virtual operating platform to the guest operating systems, and can manage the execution of the guest operating systems. Multiple instances of a variety of operating systems can share virtualized hardware resources.

Network 250 includes one or more wired and/or wireless networks. For example, network 250 can include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, a core network, and/or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

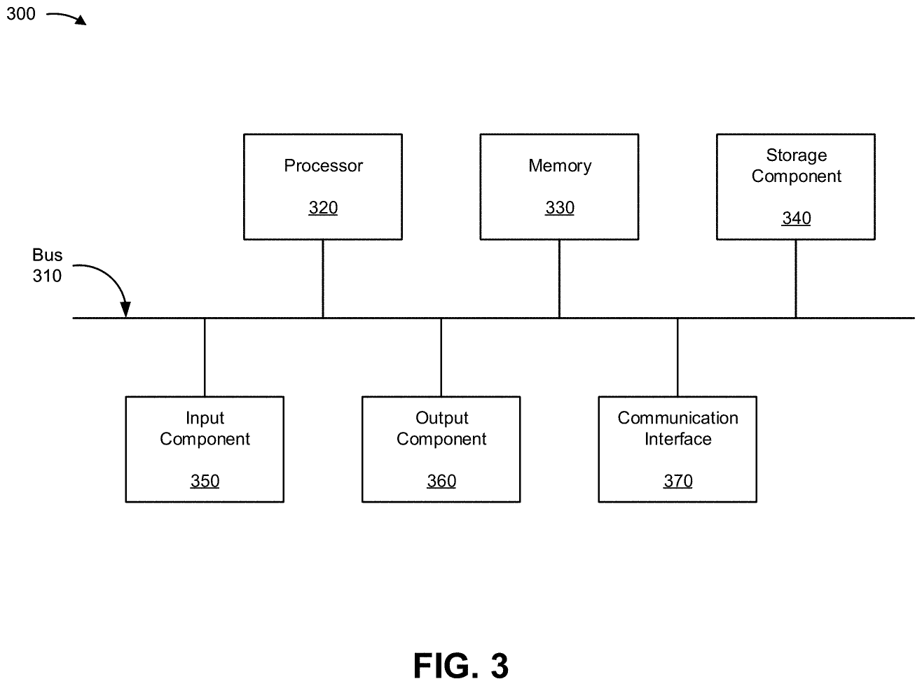

FIG. 3 is a diagram of example components of a device 300. Device 300 may correspond to user device 210, credit bureau device 220, pre-qualification platform 230, and/or the like. In some implementations, user device 210, credit bureau device 220, and/or pre-qualification platform 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among multiple components of device 300. Processor 320 is implemented in hardware, firmware, and/or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random-access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

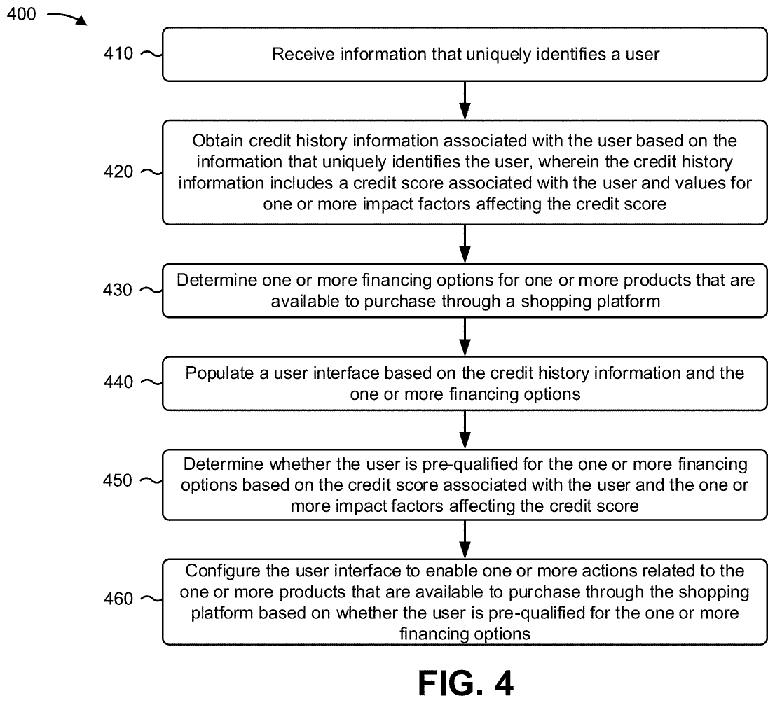

FIG. 4 is a flow chart of an example process 400 for configuring user interface functionality based on background processing of data related to pre-qualification status. In some implementations, one or more process blocks of FIG. 4 may be performed by a pre-qualification platform (e.g., pre-qualification platform 230). In some implementations, one or more process blocks of FIG. 4 may be performed by another device or a group of devices separate from or including the pre-qualification platform, such as a user device (e.g., user device 210), a credit bureau device (e.g., credit bureau device 220), and/or the like.

As shown in FIG. 4, process 400 may include receiving information that uniquely identifies a user (block 410). For example, the pre-qualification platform (e.g., using computing resource 245, processor 320, memory 330, storage component 340, input component 350, output component 360, communication interface 370, and/or the like) may receive information that uniquely identifies a user, as described above.

As further shown in FIG. 4, process 400 may include obtaining credit history information associated with the user based on the information that uniquely identifies the user, wherein the credit history information includes a credit score associated with the user and values for one or more impact factors affecting the credit score (block 420). For example, the pre-qualification platform (e.g., using computing resource 245, processor 320, memory 330, storage component 340, input component 350, output component 360, communication interface 370, and/or the like) may obtain credit history information associated with the user based on the information that uniquely identifies the user, as described above. In some implementations, the credit history information includes a credit score associated with the user and values for one or more impact factors affecting the credit score.

As further shown in FIG. 4, process 400 may include determining one or more financing options for one or more products that are available to purchase through a shopping platform (block 430). For example, the pre-qualification platform (e.g., using computing resource 245, processor 320, memory 330, storage component 340, input component 350, output component 360, communication interface 370, and/or the like) may determine one or more financing options for one or more products that are available to purchase through a shopping platform, as described above.

As further shown in FIG. 4, process 400 may include populating a user interface based on the credit history information and the one or more financing options (block 440). For example, the pre-qualification platform (e.g., using computing resource 245, processor 320, memory 330, storage component 340, input component 350, output component 360, communication interface 370, and/or the like) may populate a user interface based on the credit history information and the one or more financing options, as described above.

As further shown in FIG. 4, process 400 may include determining whether the user is pre-qualified for the one or more financing options based on the credit score associated with the user and the one or more impact factors affecting the credit score (block 450). For example, the pre-qualification platform (e.g., using computing resource 245, processor 320, memory 330, storage component 340, input component 350, output component 360, communication interface 370, and/or the like) may determine whether the user is pre-qualified for the one or more financing options based on the credit score associated with the user and the one or more impact factors affecting the credit score, as described above.

As further shown in FIG. 4, process 400 may include configuring the user interface to enable one or more actions related to the one or more products that are available to purchase through the shopping platform based on whether the user is pre-qualified for the one or more financing options (block 460). For example, the pre-qualification platform (e.g., using computing resource 245, processor 320, memory 330, storage component 340, input component 350, output component 360, communication interface 370, and/or the like) may configure the user interface to enable one or more actions related to the one or more products that are available to purchase through the shopping platform based on whether the user is pre-qualified for the one or more financing options, as described above.

Process 400 can include additional implementations, such as any single implementation or any combination of implementations described below and/or in connection with one or more other processes described elsewhere herein.

In some implementations, when obtaining the credit history information associated with the user, a background process executing on the pre-qualification platform may submit a soft inquiry to a credit bureau device requesting the credit history information associated with the user and receive the credit history information associated with the user from the credit bureau device based on the soft inquiry.

In some implementations, the pre-qualification platform may determine whether the user is pre-qualified for the one or more financing options based further on one or more financing requirements associated with a merchant offering the one or more products on the shopping platform. In some implementations, the pre-qualification platform may determine whether the user is pre-qualified for the one or more financing options based further on pre-qualification criteria associated with a plurality of lenders.

In some implementations, the one or more impact factors include at least one of a history of making payments on time, an age of one or more credit accounts, a credit utilization, a quantity of credit inquiries within a threshold time period, or a quantity of credit or loan accounts opened within the threshold time period.

In some implementations, when configuring the user interface to enable the one or more actions, the pre-qualification platform may enable an action to apply for the one or more financing options based on an indication that the user is pre-qualified for the one or more financing options.

In some implementations, when configuring the user interface to enable the one or more actions, the pre-qualification platform may enable an action to simulate one or more changes to the credit history information that would result in the user pre-qualifying for the one or more financing options based on an indication that the user does not pre-qualify for the one or more financing options. In some implementations, the one or more simulated changes to the credit history information may include one or more variations to the values for the one or more impact factors affecting the credit score.

In some implementations, when configuring the user interface to enable the one or more actions, the pre-qualification platform may enable an action to search a vehicle inventory for one or more vehicles that the user is eligible to finance based on an indication that the user is pre-qualified for the one or more financing options.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

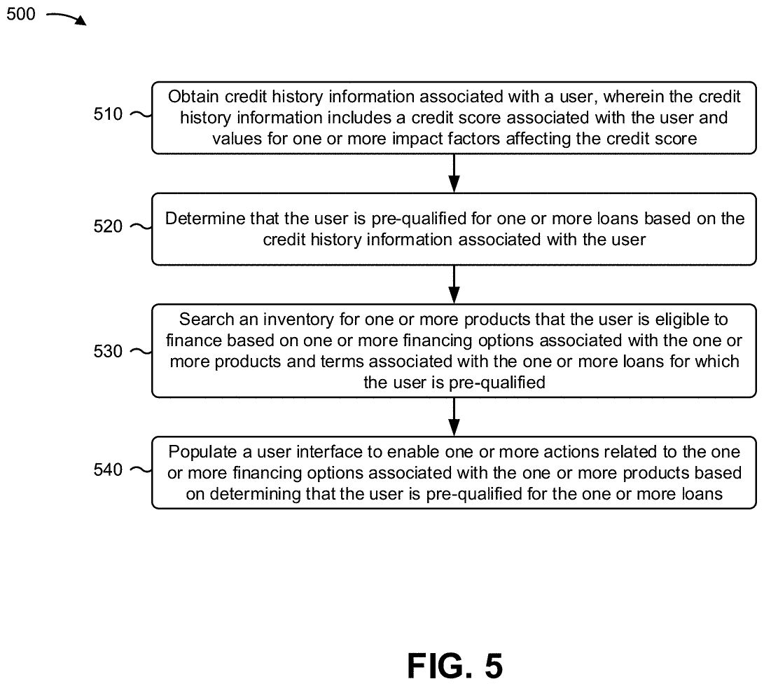

FIG. 5 is a flow chart of an example process 500 for configuring user interface functionality based on background processing of data related to pre-qualification status. In some implementations, one or more process blocks of FIG. 5 may be performed by a pre-qualification platform (e.g., pre-qualification platform 230). In some implementations, one or more process blocks of FIG. 5 may be performed by another device or a group of devices separate from or including the pre-qualification platform, such as a user device (e.g., user device 210), a credit bureau device (e.g., credit bureau device 220), and/or the like.

As shown in FIG. 5, process 500 may include obtaining credit history information associated with a user, wherein the credit history information includes a credit score associated with the user and values for one or more impact factors affecting the credit score (block 510). For example, the pre-qualification platform (e.g., using computing resource 245, processor 320, memory 330, storage component 340, input component 350, output component 360, communication interface 370, and/or the like) may obtain credit history information associated with a user, as described above. In some implementations, the credit history information includes a credit score associated with the user and values for one or more impact factors affecting the credit score.

As further shown in FIG. 5, process 500 may include determining that the user is pre-qualified for one or more loans based on the credit history information associated with the user (block 520). For example, the pre-qualification platform (e.g., using computing resource 245, processor 320, memory 330, storage component 340, input component 350, output component 360, communication interface 370, and/or the like) may determine that the user is pre-qualified for one or more loans based on the credit history information associated with the user, as described above.

As further shown in FIG. 5, process 500 may include searching an inventory for one or more products that the user is eligible to finance based on one or more financing options associated with the one or more products and terms associated with the one or more loans for which the user is pre-qualified (block 530). For example, the pre-qualification platform (e.g., using computing resource 245, processor 320, memory 330, storage component 340, input component 350, output component 360, communication interface 370, and/or the like) may search an inventory for one or more products that the user is eligible to finance based on one or more financing options associated with the one or more products and terms associated with the one or more loans for which the user is pre-qualified, as described above.

As further shown in FIG. 5, process 500 may include populating a user interface to enable one or more actions related to the one or more financing options associated with the one or more products based on determining that the user is pre-qualified for the one or more loans (block 540). For example, the pre-qualification platform (e.g., using computing resource 245, processor 320, memory 330, storage component 340, input component 350, output component 360, communication interface 370, and/or the like) may populate a user interface to enable one or more actions related to the one or more financing options associated with the one or more products based on determining that the user is pre-qualified for the one or more loans, as described above.

Process 500 can include additional implementations, such as any single implementation or any combination of implementations described below and/or in connection with one or more other processes described elsewhere herein.

In some implementations, the pre-qualification platform may determine that the user is pre-qualified for the one or more loans based on the credit score associated with the user, the values for the one or more impact factors affecting the credit score, and historical transaction data associated with the user. In some implementations, the one or more impact factors include at least one of a history of making payments on time, an age of one or more credit accounts, a credit utilization, a quantity of credit inquiries within a threshold time period, or a quantity of credit or loan accounts opened within the threshold time period.

In some implementations, the credit history information is obtained from a credit bureau device via a soft pull that does not impact the credit score associated with the user. In some implementations, the one or more actions enabled via the user interface include an action enabling the user to apply for the one or more loans. In some implementations, the one or more actions enabled via the user interface include an action enabling the user to search the inventory for one or more vehicles that the user is eligible to finance.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

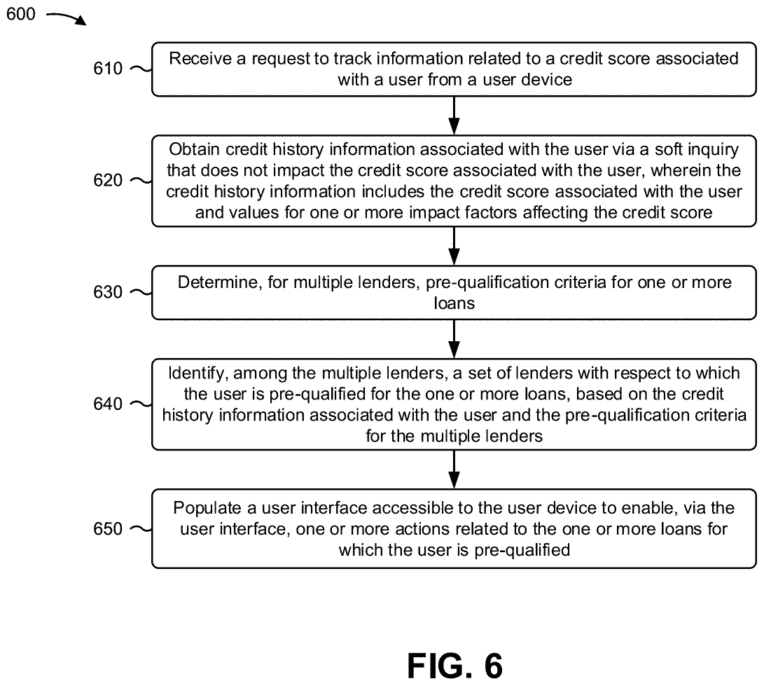

FIG. 6 is a flow chart of an example process 600 for configuring user interface functionality based on background processing of data related to pre-qualification status. In some implementations, one or more process blocks of FIG. 6 may be performed by a pre-qualification platform (e.g., pre-qualification platform 230). In some implementations, one or more process blocks of FIG. 6 may be performed by another device or a group of devices separate from or including the pre-qualification platform, such as a user device (e.g., user device 210), a credit bureau device (e.g., credit bureau device 220), and/or the like.

As shown in FIG. 6, process 600 may include receiving a request to track information related to a credit score associated with a user from a user device (block 610). For example, the pre-qualification platform (e.g., using computing resource 245, processor 320, memory 330, storage component 340, input component 350, output component 360, communication interface 370, and/or the like) may receive a request to track information related to a credit score associated with a user from a user device, as described above.

As further shown in FIG. 6, process 600 may include obtaining credit history information associated with the user via a soft inquiry that does not impact the credit score associated with the user, wherein the credit history information includes the credit score associated with the user and values for one or more impact factors affecting the credit score (block 620). For example, the pre-qualification platform (e.g., using computing resource 245, processor 320, memory 330, storage component 340, input component 350, output component 360, communication interface 370, and/or the like) may obtain credit history information associated with the user via a soft inquiry that does not impact the credit score associated with the user, as described above. In some implementations, the credit history information includes the credit score associated with the user and values for one or more impact factors affecting the credit score.

As further shown in FIG. 6, process 600 may include determining, for multiple lenders, pre-qualification criteria for one or more loans (block 630). For example, the pre-qualification platform (e.g., using computing resource 245, processor 320, memory 330, storage component 340, input component 350, output component 360, communication interface 370, and/or the like) may determine, for multiple lenders, pre-qualification criteria for one or more loans, as described above.

As further shown in FIG. 6, process 600 may include identifying, among the multiple lenders, a set of lenders with respect to which the user is pre-qualified for the one or more loans, based on the credit history information associated with the user and the pre-qualification criteria for the multiple lenders (block 640). For example, the pre-qualification platform (e.g., using computing resource 245, processor 320, memory 330, storage component 340, input component 350, output component 360, communication interface 370, and/or the like) may identify, among the multiple lenders, a set of lenders with respect to which the user is pre-qualified for the one or more loans, based on the credit history information associated with the user and the pre-qualification criteria for the multiple lenders, as described above.

As further shown in FIG. 6, process 600 may include populating a user interface accessible to the user device to enable, via the user interface, one or more actions related to the one or more loans for which the user is pre-qualified (block 650). For example, the pre-qualification platform (e.g., using computing resource 245, processor 320, memory 330, storage component 340, input component 350, output component 360, communication interface 370, and/or the like) may populate a user interface accessible to the user device to enable, via the user interface, one or more actions related to the one or more loans for which the user is pre-qualified, as described above.

Process 600 can include additional implementations, such as any single implementation or any combination of implementations described below and/or in connection with one or more other processes described elsewhere herein.

In some implementations, the pre-qualification platform may identify the set of lenders with respect to which the user is pre-qualified for the one or more loans based on the credit score associated with the user and the values for the one or more impact factors affecting the credit score. In some implementations, the pre-qualification platform may identify the set of lenders with respect to which the user is pre-qualified for the one or more loans based further on historical transaction data associated with the user.

In some implementations, the pre-qualification platform may obtain the credit history information associated with the user by submitting, to a credit bureau device, the soft inquiry to request the credit history information associated with the user and receiving, from the credit bureau device, the credit history information associated with the user based on the soft inquiry.

In some implementations, the one or more actions enabled via the user interface include an action enabling the user to apply for the one or more loans through at least one lender in the set of lenders. In some implementations, the one or more actions enabled via the user interface include an action enabling the user to search a vehicle inventory for one or more vehicles that the user is eligible to finance through at least one lender in the set of lenders.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, and/or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, and/or the like). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1-8. (canceled)

9. A device, comprising:
one or more memories; and
one or more processors, communicatively coupled to the one or more memories, configured to:
automatically obtain credit history information associated with a user from a database,
wherein the credit history information includes a credit score associated with the user and values for one or more impact factors affecting the credit score;
determine, based on the credit history information associated with the user, that the user is pre-qualified for one or more loans satisfying a threshold amount and a threshold monthly payment;
receive information associated with a plurality of products,
the information associated with the plurality of products being received based on the user browsing a shopping platform associated with the plurality of products;
identify a first set of financing options, associated with a first set of products, of the plurality of products, that satisfy the threshold amount and the threshold monthly payment;
identify a second set of products, of the plurality of products, for which the user is not prequalified for one or more loans to purchase the second set of products;
and
populate a user interface with one or more user interface elements that, upon actuation, enable one or more first actions related to obtaining the first set of financing options associated with the first set of products.

10. The device of claim 9, wherein the one or more processors, when determining that the user is pre-qualified for the one or more loans, are configured to:
determine that the user is pre-qualified for the one or more loans based on historical transaction data associated with the user.

11. The device of claim 9, wherein the one or more impact factors include at least one of:
a history of making payments on time,
an age of one or more credit accounts,
a credit utilization,
a quantity of credit inquiries within a threshold time period, or
a quantity of credit or loan accounts opened within the threshold time period.

12. The device of claim 9, wherein the credit history information is obtained from a credit bureau device via a soft pull that does not impact the credit score associated with the user.

13. The device of claim 9, wherein the one or more first actions enabled via the one or more user interface elements include an action enabling the user to apply for the first set of financing options.

14-20. (canceled)

21. The device of claim 9, wherein the one or more processors are further configured to:
train a model based on historical credit data; and
wherein the one or more processors, when determining that the user is pre-qualified for the one or more loans, are configured to:
determine that the user is pre-qualified for the one or more loans using the model.

22. The device of claim 9, wherein the one or more processors are further configured to:
pre-process the credit history information;
train a model based on using the pre-processed credit history information; and
wherein the one or more processors, when determining that the user is pre-qualified for the one or more loans, are configured to:
determine that the user is pre-qualified for the one or more loans using the model.

23. A method, comprising:
automatically obtaining, by a device, credit history information associated with a user from a database,
wherein the credit history information includes a credit score associated with the user and values for one or more impact factors affecting the credit score;
determining, by the device and based on the credit history information associated with the user, that the user is pre-qualified for one or more loans satisfying a threshold amount and a threshold monthly payment;
populating, by the device, a first user interface with one or more first user interface elements to enable a pre-qualification action based on determining that the user is pre-qualified;
receiving, by the device, information associated with a plurality of products,
the information associated with the plurality of products being received based on the user browsing a shopping platform associated with the plurality of products;
identifying, by the device, a first set of financing options, associated with a first set of products, of the plurality of products, that satisfy the threshold amount and the threshold monthly payment;
identifying, by the device, a second set of financing a second set of products, of the plurality of products, for which the user is not prequalified for one or more loans to purchase the second set of products;
and
populating, by the device, a second user interface with one or more second user interface elements that only enable one or more first actions related to the first set of financing options associated with the first set of products,
wherein actuation of the one or more second user interface elements enable the one or more first actions to be performed,
wherein the one or more first actions include:
a first action, of the one or more first actions, to apply for the first set of financing options, or
a second action, of the one or more first actions, to search inventory associated with the shopping platform for one or more additional products that the user is pre-qualified to finance.

24. The method of claim 23, wherein determining that the user is pre-qualified for the one or more loans comprises:
determining that the user is pre-qualified for the one or more loans based on historical transaction data associated with the user.

25. The method of claim 23, wherein the one or more impact factors include at least one of:
a history of making payments on time,
an age of one or more credit accounts,
a credit utilization,
a quantity of credit inquiries within a threshold time period, or
a quantity of credit or loan accounts opened within the threshold time period.

26. The method of claim 23, wherein the credit history information is obtained from a credit bureau device via a soft pull that does not impact the credit score associated with the user.

27. (canceled)

28. The method of claim 23, further comprising:
training a model based on historical credit data; and
wherein determining that the user is pre-qualified for the one or more loans comprises:
determining that the user is pre-qualified for the one or more loans using the model.

29. The method of claim 23, further comprising:
pre-processing the credit history information;
training a model using the pre-processed credit history information; and
wherein determining that the user is pre-qualified for the one or more loans comprises:
determining that the user is pre-qualified for the one or more loans using the model.

30. A non-transitory computer-readable medium storing instructions, the instructions comprising:
one or more instructions that, when executed by one or more processors, cause the one or more processors to:
automatically obtain credit history information associated with a user from a database,
wherein the credit history information includes a credit score associated with the user and values for one or more impact factors affecting the credit score;
determine, based on the credit history information associated with the user, that the user is pre-qualified for one or more loans satisfying a threshold amount and a threshold monthly payment;
receive information associated with a plurality of products,
the information associated with the plurality of products being received based on the user browsing a shopping platform associated with the plurality of products;
identify a first set of financing options, associated with a first set of products, of the plurality of products, that satisfy the threshold amount and the threshold monthly payment;
identify a second set of products, of the plurality of products, for which the user is not prequalified for one or more loans to purchase the second set of products;
and
populate a user interface, associated with the shopping platform, with one or more user interface elements that, upon actuation, only enable one or more first actions related to the first set of financing options.

31. The non-transitory computer-readable medium of claim 30, wherein the one or more instructions, that cause the one or more processors to determine that the user is pre-qualified for the one or more loans, cause the one or more processors to:
determine that the user is pre-qualified for the one or more loans based on historical transaction data associated with the user.

32. The non-transitory computer-readable medium of claim 30, wherein the one or more impact factors include at least one of:
a history of making payments on time,
an age of one or more credit accounts,
a credit utilization,
a quantity of credit inquiries within a threshold time period, or
a quantity of credit or loan accounts opened within the threshold time period.

33. The non-transitory computer-readable medium of claim 30, wherein the credit history information is obtained from a credit bureau device via a soft pull that does not impact the credit score associated with the user.

34. The non-transitory computer-readable medium of claim 30, wherein the one or more first actions enabled via the one or more user interface elements include an action enabling the user to apply for the first set of financing options.

35. The non-transitory computer-readable medium of claim 30, wherein the one or more instructions, when executed by the one or more processors, further cause the one or more processors to:
train a model based on historical credit data; and
wherein the one or more instructions, that cause the one or more processors to determine that the user is pre-qualified for the one or more loans, cause the one or more processors to:
determine that the user is pre-qualified for the one or more loans using the model.

36. The device of claim 9, wherein the one or more processors are further to:
populate another user interface with at least one user interface element to enable a pre-qualification action based on determining that the user is pre-qualified.
